(19) United States
(12) Patent Application Publication
(10) Pub. No.: US 2015/0372757 A1
(43) Pub. Date: Dec. 24, 2015

(54) ALIGNING OPTICAL ELEMENTS OF AN OPTICAL TRANSCEIVER SYSTEM

(71) Applicant: Avago Technologies General IP (Singapore) Pte. Ltd., Singapore (SG)

(72) Inventors: Michael J. Brosnan, Fremont, CA (US); Omid Momtahan, Palo Alto, CA (US); David J.K. Meadowcroft, San Jose, CA (US); Li Ding, Pleasanton, CA (US); Paul Yu, Sunnyvale, CA (US)

(21) Appl. No.: 14/311,275

(22) Filed: Jun. 21, 2014

(51) Int. Cl. H04B 10/40; H04B 10/2575

(52) U.S. Cl. CPC H04B 10/40; H04B 10/2575

(57) ABSTRACT

In a method for making an optical communications module, elements in the optical signal path are aligned relative to a lens mounting frame. The frame is attached to the surface of a printed circuit board. The frame bears fiducial markings. An opto-electronic device is then aligned relative to the frame using the fiducial markings. One or more bottom lens devices are aligned relative to the lens mounting frame using the fiducial markings. Finally, a top lens device is attached to the lens mounting frame over the bottom lens devices.

### BACKGROUND

Optical data transceiver modules convert optical signals received via an optical fiber into electrical signals, and convert electrical signals into optical signals for transmission via an optical fiber. In the transmitter portion of a transceiver module, an opto-electronic light source such as a laser performs the electrical-to-optical signal conversion. In the receiver portion of the transceiver module, an opto-electronic light detector such as a photodiode performs the optical-to-electrical signal conversion. A transceiver module commonly also includes optical elements, such as lenses, as well as electrical circuitry such as drivers and receivers. A transceiver module also includes one or more fiber ports to which an optical fiber cable is connected. The light source, light detector, optical elements and electrical circuitry are mounted within a module housing. The one or more fiber ports are located on the module housing.

Demand continues for transceiver modules having increasingly higher data rates. Achieving high data rates in a transceiver module requires high precision in the optical alignment among lenses, light sources, light detectors, and other elements in the optical path. Aligning such elements during the transceiver module manufacturing process is only part of the challenge facing practitioners in the art. A related challenge is maintaining the elements in such alignment. One impediment to maintaining alignment is known as epoxy cure drift. Once a lens has been aligned with the light source or light detector, it needs to be secured in place. Epoxy is commonly used to adhere the lens in place. An epoxy that maintains high adhesion strength even when subjected to high temperatures, humidity and mechanical forces is commonly employed to withstand such conditions, which can occur during normal use of the transceiver module. Such high-strength epoxy or “structural epoxy” commonly requires a higher temperature to fully cure than adhesives having lower adhesion strength, such as room temperature-cure epoxies and light-cure epoxies. However, epoxy cure drift can occur if the high curing temperature causes the lens to thermally expand out of alignment.

Various transceiver module configurations are known. One type of transceiver module configuration is known as Small Form Factor Pluggable (SFP). Such SFP transceiver modules include an elongated housing having a substantially rectangular cross-sectional shape. A forward end of the housing is connectable to an optical fiber cable. A rearward end of the housing has an array of electrical contacts that can be plugged into a mating connector when the rearward end is inserted or plugged into a slot of a network switch or other device. An SFP transceiver module having four parallel transmit channels and four parallel receive channels is commonly referred to as Quad SFP or QSFP.

In some transceiver modules, the light source and light detector are mounted on a printed circuit board (PCB) with their optical axes normal to the plane of the PCB. As these device optical axes are perpendicular to the ends of the optical fibers, there is a need to redirect or “turn” the signal path 90 degrees between the fibers and the device optical axes. In some transceiver modules, a 90-degree signal path turn is accomplished in the electrical domain by, for example, a flex circuit. In other transceiver modules, the turn is accomplished in the optical domain by a reflective surface.

It would be desirable to provide an improved method for achieving and maintaining optical alignment among elements in an optical data transceiver module.

### SUMMARY

Embodiments of the present invention relate to a method for making an electro-optical assembly of an optical communications module, in which elements in the optical signal path are aligned relative to a lens mounting frame. In an exemplary embodiment, the lens mounting frame has a generally planar shape and a perimeter surrounding an interior opening. The perimeter has a frame lower surface defining a first plane and a frame upper surface defining a second plane. The frame upper surface bears fiducial markings. The lens mounting frame is attached to the surface of the printed circuit board (PCB) by attaching the frame lower surface to the surface of the PCB.

An opto-electronic device is then aligned relative to the lens mounting frame by detecting the fiducial markings and moving the opto-electronic device into an aligned opto-electronic device position in response to detection of the fiducial markings. The opto-electronic device is secured to the surface of the PCB in the aligned opto-electronic device position.

A bottom lens device is then aligned relative to the lens mounting frame by detecting the fiducial markings and moving the bottom lens device into an aligned lens device position over the opto-electronic device in response to detection of the fiducial markings. The bottom lens device is secured in the aligned lens device position.

A top lens device is then attached to the lens mounting frame by placing a base portion of the top lens device in contact with the frame upper surface.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a perspective view of an optical communications module, in accordance with embodiments of the present invention.

FIG. 2 is similar to FIG. 1 but with the upper module housing removed to reveal the module interior.

FIG. 3 is a top perspective view of the lens mounting frame of the optical communications module of FIGS. 1-2.

FIG. 4 is bottom perspective view of the lens mounting frame of the optical communications module of FIGS. 1-2.

FIG. 5 is a plan view of an assembly comprising the lens mounting frame mounted on a printed circuit board (PCB).

FIG. 6 is a plan view of an assembly comprising the lens mounting frame, an opto-electronic light source, an opto-electronic light detector, and electronic devices, mounted on the printed circuit board (PCB).

FIG. 7 is a perspective view of a bottom lens device.

FIG. 8 is a plan view of an assembly similar to the assembly of FIG. 6 but with a transmit bottom lens device and a receive bottom lens device mounted on the PCB.

FIG. 9 is a top perspective view of a top lens device.

FIG. 10 is a bottom perspective view of the top lens device.

FIG. 11 illustrates mounting the top lens device of FIGS. 9-10 on the assembly of FIG. 8.

FIG. 12 is a front elevation view of the assembly of FIG. 11.

FIG. 13 is a plan view of the assembly of FIG. 11.

FIG. 14 is a sectional view taken on line 14-14 of FIG. 13.

FIG. 15 is a front perspective view of the assembly of FIGS. 12-13 with a guide pin system further included.

FIG. 16 is a rear perspective view of the assembly of FIG. 15.

FIG. 17 is an enlargement of a portion of FIG. 14.

FIG. 18 is a flowchart illustrating a method for making the electro-optical sub-assembly of the optical communications module.

### DETAILED DESCRIPTION

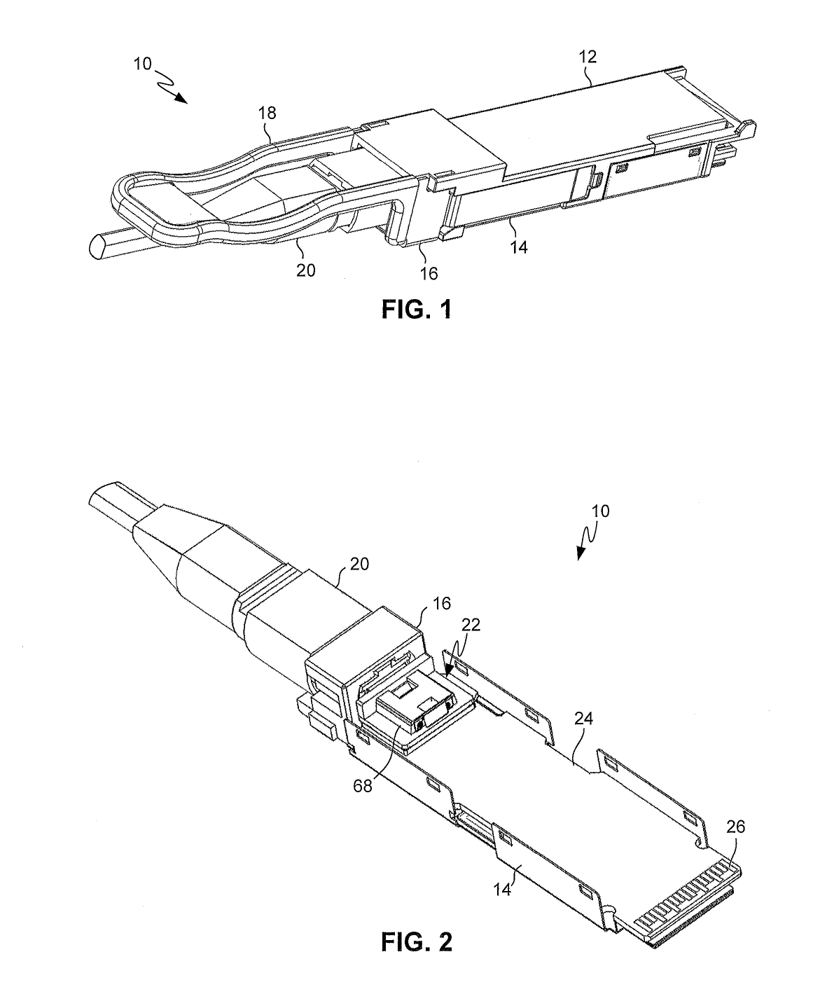

As illustrated in FIGS. 1-2, in an illustrative or exemplary embodiment of the invention, an optical communications module 10 includes an upper module housing 12, a lower module housing 14, a housing nose 16, and a delatch assembly 18, arranged in a generally SFP module configuration. Upper module housing 12, lower module housing 14, and housing nose 16 together define a module housing. Housing nose 16 defines a forward end of optical communications module 10 and in the exemplary embodiment is configured to mate with a conventional multiple-fiber push-on (MPO) connector 20. As the structure and operation of MPO connector 20 are well understood in the art, such aspects are not described in detail herein. It is sufficient to note that an end face (not shown) of MPO connector 20 retains the ends of a plurality of optical fibers in an array. Although in the exemplary embodiment housing nose 16 is configured to mate with MPO connector 20, in other embodiments (not shown), such a housing nose can be configured to mate with other types of connectors or to provide an active optical cable (AOC) connection.

As illustrated in FIG. 2, an electro-optical sub-assembly 22 includes an elongated printed circuit board (PCB) 24 retained in lower module housing 14. A plurality of electrical contact pads 26 are arrayed on the surface of PCB 24 at a rearward end of optical communications module 10. Although not shown for purposes of clarity, integrated circuit packages and other electronic devices can be mounted on the surface of PCB 22. Although also not shown for purposes of clarity, PCB 24 includes circuit traces for interconnecting such electronic devices with electrical contact pads 26 and other opto-electronic and electronic elements described below.

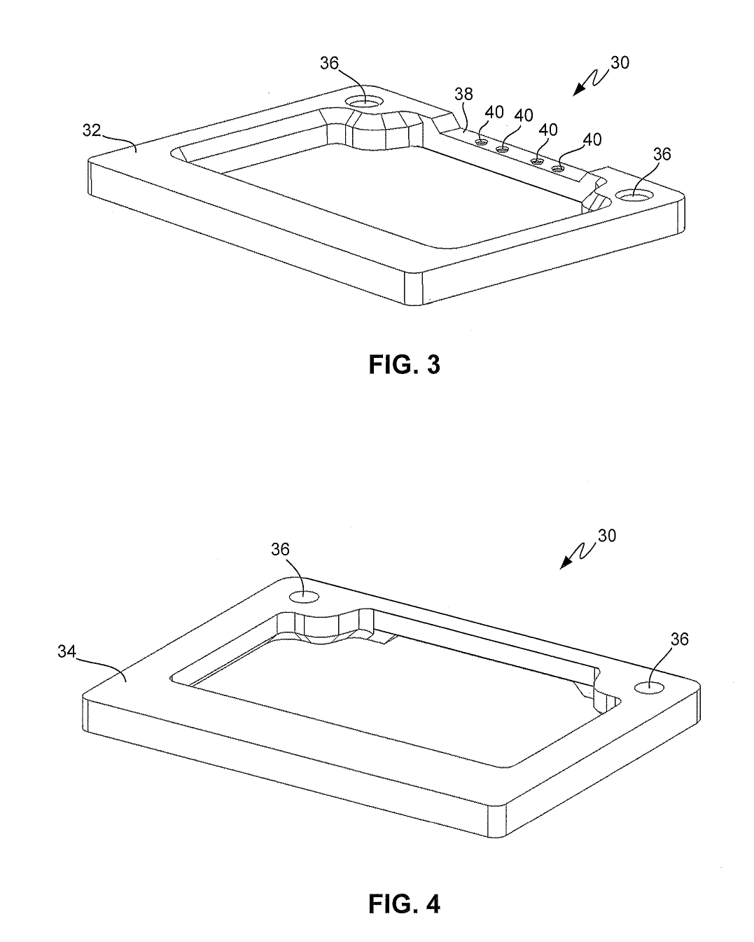

As illustrated in FIGS. 3-4, a lens mounting frame 30 has a substantially planar and rectangular shape, with a continuous perimeter surrounding an open interior region (in the manner of, for example, a picture frame). The substantially planar shape of lens mounting frame 30 is defined by an upper surface 32 having a substantially planar shape that is parallel to a lower surface 34 having a substantially planar shape. Upper surface 32 is only substantially planar rather than exactly planar because it has two alignment holes 36 as well as an indented section 38 that bears fiducial markings 40. Lens mounting frame 30 can consist of a suitable molded optical plastic material, such as ULTEM amorphous thermoplastic polyetherimide, available from SABIC Innovative Plastics of Saudi Arabia.

Although in the exemplary embodiment upper surface 32 has an indented section 38, in other embodiments (not shown) such an upper surface of such a lens mounting frame need not have an indented section. Also, in other embodiments, any other suitable portion of the upper surface of such a lens mounting frame can bear fiducial markings. Although in the exemplary embodiment there are four fiducial markings 40 arranged in a linear array, in other embodiments there can be any other suitable number of such fiducial markings arranged in any other suitable manner.

Fiducial markings 40 are molded into lens mounting frame 30 or otherwise co-formed with the remainder of lens mounting frame 30. That is, the same mold (not shown) and molding process step that produces the remainder of lens mounting frame 30 at the same time produces (i.e., co-forms) fiducial markings 40. Note that as lens mounting frame 30 in the exemplary embodiment consists of the molded plastic material, lens mounting frame 30 is a solid mass of such material. That is, in lens mounting frame 30 nothing but the molded plastic material exists between fiducial markings 40 and alignment holes 36. This molded characteristic of lens mounting frame 30 thus ensures that the relative locations or positioning between fiducial markings 40 and alignment holes 36 can be fixed with high precision.

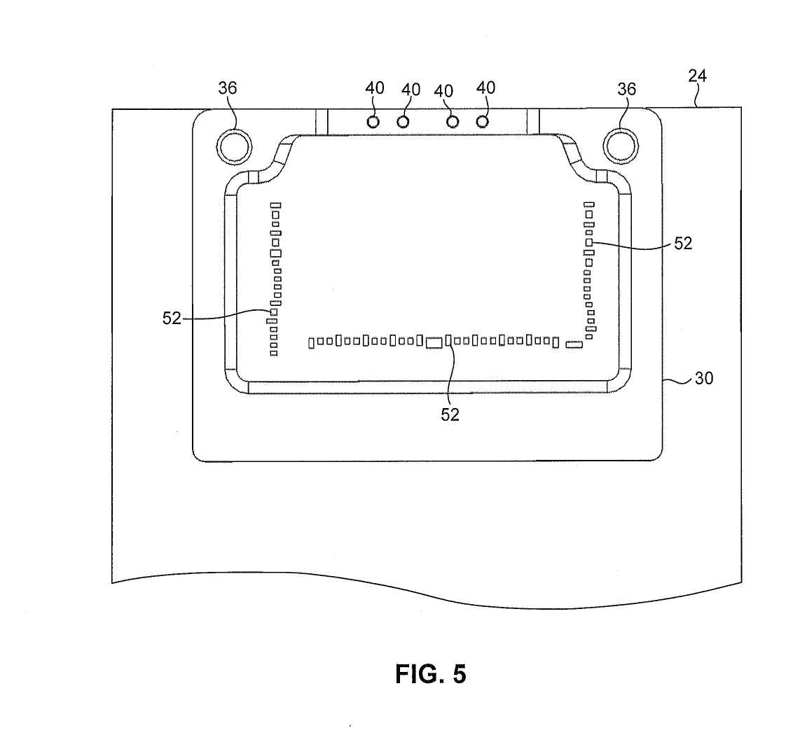

As illustrated in FIG. 5, lens mounting frame 30 is mounted on PCB 24, with lower surface 34 of lens mounting frame 30 contacting the planar surface of PCB 24. Lens mounting frame 30 can be mounted on PCB 24 with a suitable adhesive, such as epoxy (not shown). As lens mounting frame 30 may be subjected to mechanical forces during use of optical communications module 10 in the manner described below, a structural epoxy is suitable. The alignment method described below ensures that any epoxy cure drift that may occur when lens mounting frame 30 is mounted on PCB 24 is immaterial to achieving and maintaining optical alignment.

Each fiducial marking 40 can comprise a circular pit or similar feature that is readily optically detectable by a robotic pick-and-place machine or similar manufacturing system (not shown). The use of fiducial markings 40 in the manufacturing process is described in further detail below.

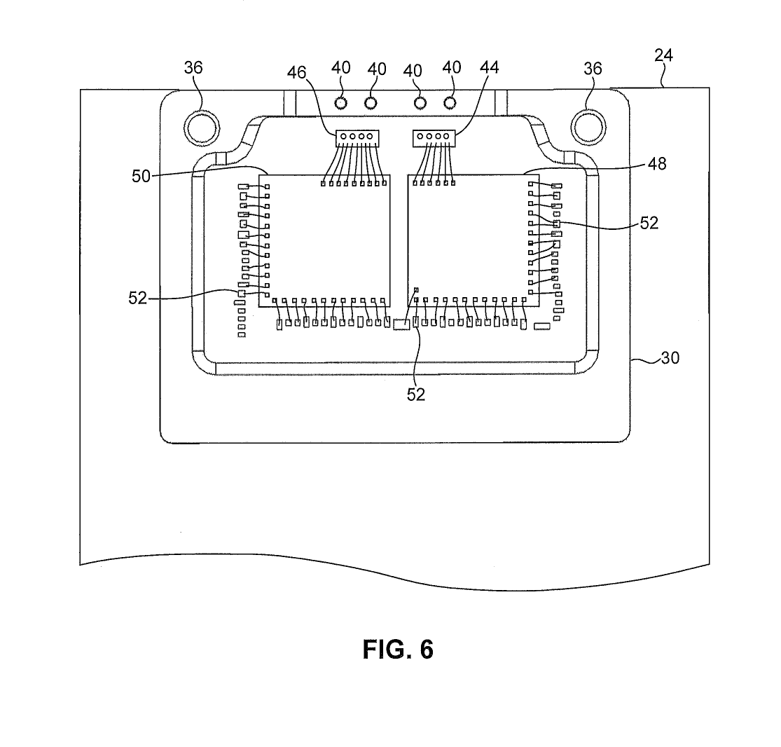

As illustrated in FIG. 6, after lens mounting frame 30 has been mounted on the surface of PCB 24, an opto-electronic light source 44 and an opto-electronic light detector 46 are mounted on the surface of PCB 24. The pick-and-place machine can optically detect fiducial markings 40 and move opto-electronic light source 44 and opto-electronic light detector 46 into aligned positions in response to detection of fiducial markings 40. That is, the pick- and place machine determines the difference between detected positions of fiducial markings 40 and the position of opto-electronic light source 44 and uses this difference as feedback to move or reposition opto-electronic light source 44 until opto-electronic light source 44 arrives at a predetermined position (“aligned position”) relative to fiducial markings 40. A Cartesian or two-dimensional (X,Y) coordinate system can be used, for example, to define positions. Likewise, the pick- and place machine determines the difference between detected positions of fiducial markings 40 and the position of opto-electronic light detector 46 and uses this difference as feedback to move or reposition opto-electronic light detector 46 until opto-electronic light detector 46 arrives at a predetermined position (“aligned position”) relative to fiducial markings 40. Opto-electronic light source 44 and opto-electronic light detector 46 are then die-attached to the surface of PCB 24 in their respective aligned positions.

Opto-electronic light source 44 can be, for example, a vertical cavity surface-emitting laser (VCSEL) chip with an array of (e.g., four) laser elements (not individually shown for purposes of clarity). In operation, the laser elements emit light beams, i.e., optical transmit signals, along respective optical axes normal to the surface of PCB 24. Opto-electronic light detector 46 can be, for example, a PIN photodiode chip with an array of (e.g., four) photodiode elements (not individually shown for purposes of clarity). In operation, the photodiode elements detect light beams, i.e., optical receive signals, along respective optical axes normal to the surface of PCB 24.

Additional electronic elements, such as a driver chip 48 and a receiver chip 50, can also be die-attached to the surface of PCB 24. Opto-electronic light source 44 and opto-electronic light detector 46, as well as driver chip 48 and receiver chip 50, can be electrically interconnected to each other and to printed circuit pads 52 on PCB 24 by wirebonding. Printed circuit pads 52 are coupled to circuit traces (not shown for purposes of clarity) in PCB 24, and such circuit traces are, in turn, coupled to electrical contact pads 26 (FIG. 2).

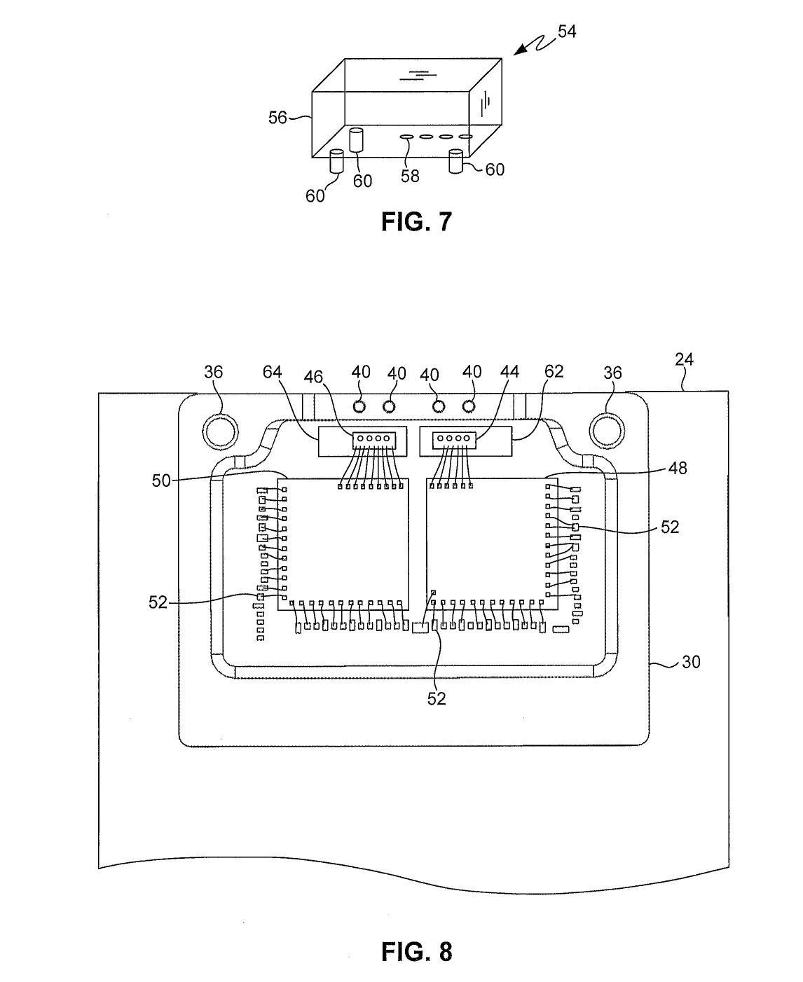

As illustrated in FIG. 7, a bottom lens device 54 consists of a generally brick-shaped mass or block 56 of optically transparent material, such as, for example, ULTEM, glass, etc. Bottom lens device 54 has an array of (e.g., four) lenses or “lenslets” 58 formed in a lower surface of block 56. Bottom lens device 54 includes mounting feet or standoffs 60 extending from the lower surface. Bottom lens device 54 can be formed by molding a suitable moldable material, such as ULTEM, by applying photolithography to a glass substrate, or other suitable methods.

As illustrated in FIG. 8, a transmit bottom lens device 62 and a receive bottom lens device 64 are mounted on PCB 24 over opto-electronic light source 44 and opto-electronic light detector 46, respectively. Transmit bottom lens device 62 and receive bottom lens device 64 each can be similar to above-described bottom lens device 54. As mounted, standoffs 60 (FIG. 7) contact the surface of PCB 24, and lenslets 58 are aligned with the corresponding optical axes of opto-electronic light source 44 and opto-electronic light detector 46.

More specifically, the robotic pick-and-place machine can optically detect fiducial markings 40 and move transmit bottom lens device 62 and receive bottom lens device 64 into respective aligned positions in response to detection of fiducial markings 40. That is, the pick- and place machine determines the difference between detected positions of fiducial markings 40 and the position of transmit bottom lens device 62 and uses this difference as feedback to move or reposition transmit bottom lens device 72 until transmit bottom lens device 62 arrives at its predetermined aligned position relative to fiducial markings 40. Likewise, the pick- and place machine determines the difference between detected positions of fiducial markings 40 and the position of receive bottom lens device 64 and uses this difference as feedback to move or reposition receive bottom lens device 64 until receive bottom lens device 64 arrives at its predetermined aligned position relative to fiducial markings 40. Transmit bottom lens device 62 and receive bottom lens device 64 are secured to the surface of PCB 24 in these aligned positions by, for example, epoxy. Significantly, a structural epoxy that would require curing at high temperature is not used to secure transmit bottom lens device 62 and receive bottom lens device 64. As transmit bottom lens device 62 and receive bottom lens device 64 are not subject to mechanical forces during normal use of optical communications module 10, a structural epoxy is not needed. Rather, a light-curable epoxy or a room-temperature-curable epoxy can be used, as the curing of such epoxies produces little to no epoxy cure drift from the aligned positions. Such non-structural epoxies are also referred to as tacking epoxies.

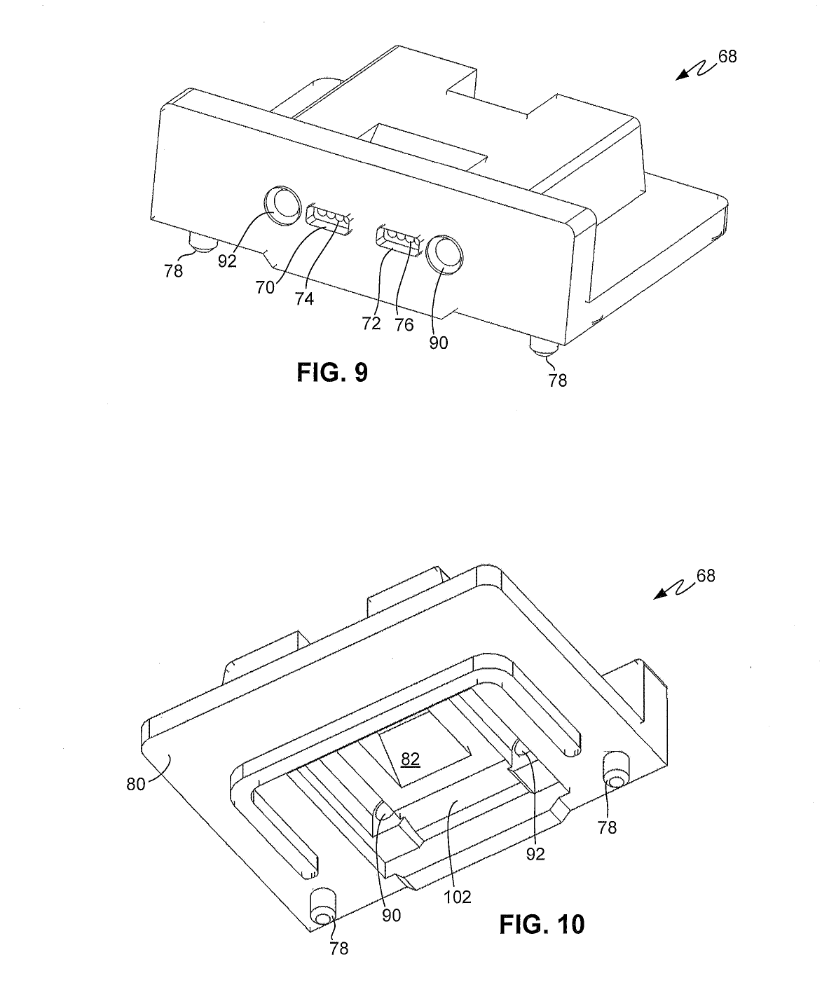

As illustrated in FIGS. 9-10, a top lens device 68 consists of a molded plastic material, such as ULTEM, which is optically transparent to the wavelengths of the signals transmitted and received by optical communications module 10. The material from which top lens device 68 is molded can be the same or essentially the same as the material from which lens mounting frame 30 is molded to provide matching thermal expansion characteristics.

Top lens device 68 has a transmit fiber port 70 and a receive fiber port 72. Transmit and receive fiber ports 70 and 72 include arrays of lenslets 74 and 76, respectively. In operation, lenslets 74 focus the transmit optical signals on the ends of transmit fibers (not shown) of MPO connector 20 (FIGS. 1-2), and lenslets 76 substantially collimate the receive optical signals emitted from the ends of receive fibers (not shown) of MPO connector 20. Although in the exemplary embodiment MPO connector 20 mates with optical communications module 10, in other embodiments (not shown) other types of devices can be coupled with such an optical communications module. For example, in an embodiment (not shown) in which the optical communications module is included in an active optical cable (AOC), the ends of the AOC fibers would be retained in bores in the fiber ports of a suitably configured top lens device.

Two alignment posts 78 extend from the lower surface of top lens device 68. Alignment posts 78 are molded into top lens device 68, i.e., co-formed with the remainder of top lens device 68, in a manner similar to that described above in which alignment holes 36 and fiducials 38 are co-formed with the remainder of lens mounting frame 30. That is, the same mold (not shown) and molding process step that produces the remainder of top lens device 68 at the same time produces alignment posts 78. Note that as top lens device 68 in the exemplary embodiment consists of the molded plastic material, top lens device 68 is a solid mass of such material. That is, in top lens device 68 nothing but the molded plastic material exists between alignment posts 78 and lenslets 74 and 76. This molded characteristic of top lens device 68 thus ensures that the relative locations or positioning between alignment posts 78 and lenslets 74 and 76 can be fixed with high precision.

As illustrated in FIG. 10, top lens device 68 has a substantially planar lower surface 80 on its underside. The underside of top lens device 68 has a cavity 82. A reflective surface 84 (FIG. 14) is formed in a wall of cavity 82. During operation of optical communications module 10, reflective surface 84 reflects the optical signals in the manner described below.

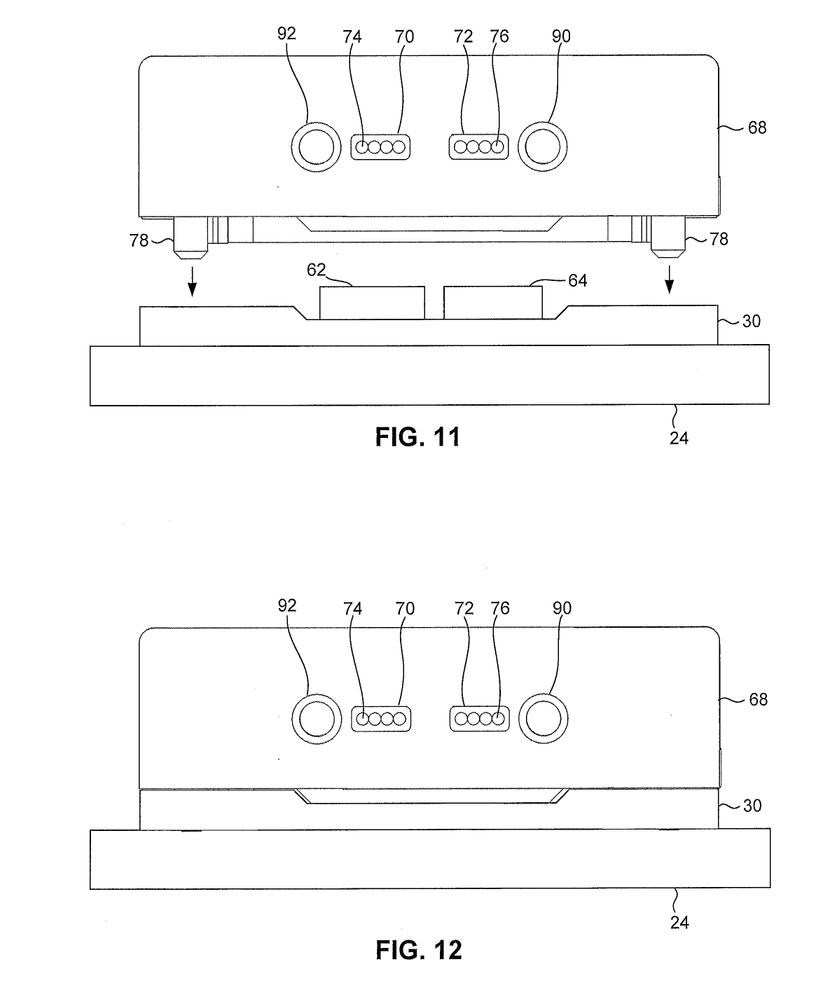

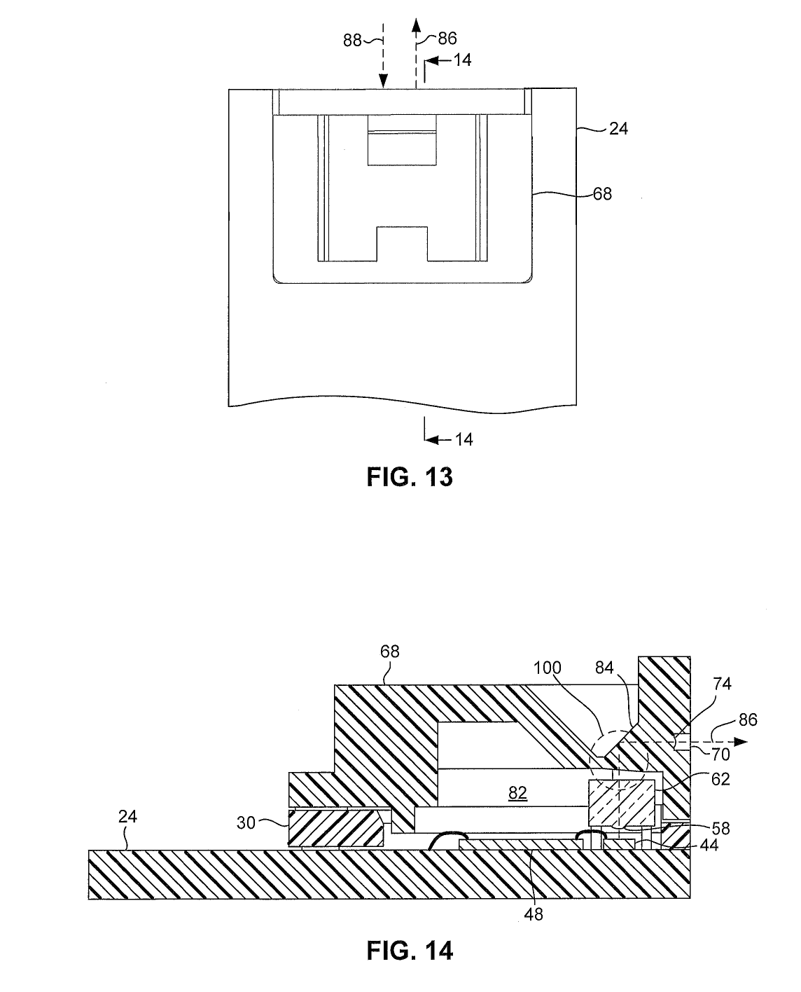

As illustrated in FIG. 11, top lens device 68 is then mounted on lens mounting frame 30. As top lens device 68 is lowered onto or otherwise caused to approach lens mounting frame 30 (in the direction of the arrows in FIG. 11), alignment posts 78 of top lens device 68 are guided by and received into alignment holes 36 (FIG. 8) in lens mounting frame 30. In the mounted position shown in FIGS. 12-13, the lower surface of top lens device 68 contacts the upper surface of lens mounting frame 30. In the mounted position, lenslets 74 are precisely positioned with respect to lenslets 58 of transmit bottom lens device 62 and with respect to the optical axes of opto-electronic light source 44 because the relative positions between alignment posts 78 and lenslets 74 are fixed with high precision due to the above-described molded characteristic of top lens device 68; and the relative positions between alignment holes 36 and lenslets 58 of transmit bottom lens device 62 are fixed with high precision due to the above-described mutual alignment with respect to fiducials 40. Likewise, lenslets 76 are precisely positioned with respect to lenslets 58 of receive bottom lens device 64 and with respect to the optical axes of opto-electronic light detector 46 because the relative positions between alignment posts 78 and lenslets 76 are fixed with high precision due to the above-described molded characteristic of top lens device 68; and the relative positions between alignment holes 36 and lenslets 58 of receive bottom lens device 64 are fixed with high precision due to the above-described mutual alignment with respect to fiducials 40.

It should be noted that the above-described features obviate aligning top lens device 68 with lens mounting frame 30 by any other means than the mating of alignment posts 78 with alignment holes 36. That is, the mating of alignment posts 78 with alignment holes 36 is by itself a sufficient (passive) alignment method, and no additional alignment methods, such as an active method involving feedback, need be performed.

Top lens device 68 can be secured to lens mounting frame 30 by structural epoxy or laser welding. Lens mounting frame 30 can be optically opaque to facilitate laser welding by directing a laser beam (not shown) through top lens device 68 and into lens mounting frame 30. Due to its opacity, lens mounting frame 30 absorbs the laser energy and transforms it into heat, which fuses the lower surface of top lens device 68 to the upper surface of lens mounting frame 30 to form a weld. Such methods for securing top lens device 68 to lens mounting frame 68 do not affect the above-described alignment, since the mating of alignment posts 78 with alignment holes 36 retains top lens device 68 in alignment during any further securing steps. There is no epoxy cure drift.

As illustrated in FIGS. 13-14, in operation opto-electronic light source 44 emits the transmit optical signals (i.e., a light beam) in response to electrical signals it receives via electronic circuitry comprising driver chip 48 and circuit traces of PCB 24. That is, opto-electronic light source 44 converts the electrical signals into optical signals. This electronic circuitry is coupled to the electrical contact pads 26 at the rearward end of PCB 24 (FIG. 2), which thus can receive corresponding electronic signals from an external system (not shown) into which optical communications device 10 is plugged. Transmit bottom lens device 62 focuses the transmit optical signals upon reflective surface 84. Reflective surface 84 redirects the transmit optical signals at an angle of substantially 90 degrees into transmit fiber port 70, from which the transmit optical signals are emitted. In FIGS. 13-14, the transmit optical path 86 along which the transmit optical signals propagate in the above-described manner is indicated by a broken-line arrow.

Note that a space or air gap exists in cavity 82 between transmit bottom lens device 62 and the interior of top lens device 68. That is, transmit bottom lens device 62 extends into cavity 82 but does not contact any portion of top lens device 68. Although not shown in FIG. 14, receive bottom lens device 64 is similarly spaced apart from top lens device 68 by a gap.

Although not shown in FIG. 14, the receive optical signals entering receive fiber port 72 impinge upon reflective surface 84, which redirects the receive optical signals at an angle of substantially 90 degrees into receive bottom lens device 64. Receive bottom lens device 64 focuses the receive optical signals onto opto-electronic light detector 46. Although the receive optical path 88 (FIG. 13) along which the receive optical signals propagate is not shown in the cross-sectional view of FIG. 14, it can be noted that receive optical path 88 is similar to the above-described transmit optical path 86. In response to the receive optical signals, opto-electronic light detector 46 produces electrical signals, which are provided to electronic circuitry comprising receiver chip 50 and circuit traces of PCB 24. That is, opto-electronic light detector 46 converts the receive optical signals into electrical signals. The plurality of electrical contact pads 26 can output corresponding electronic signals to an external system (not shown) into which optical communications device 10 is plugged.

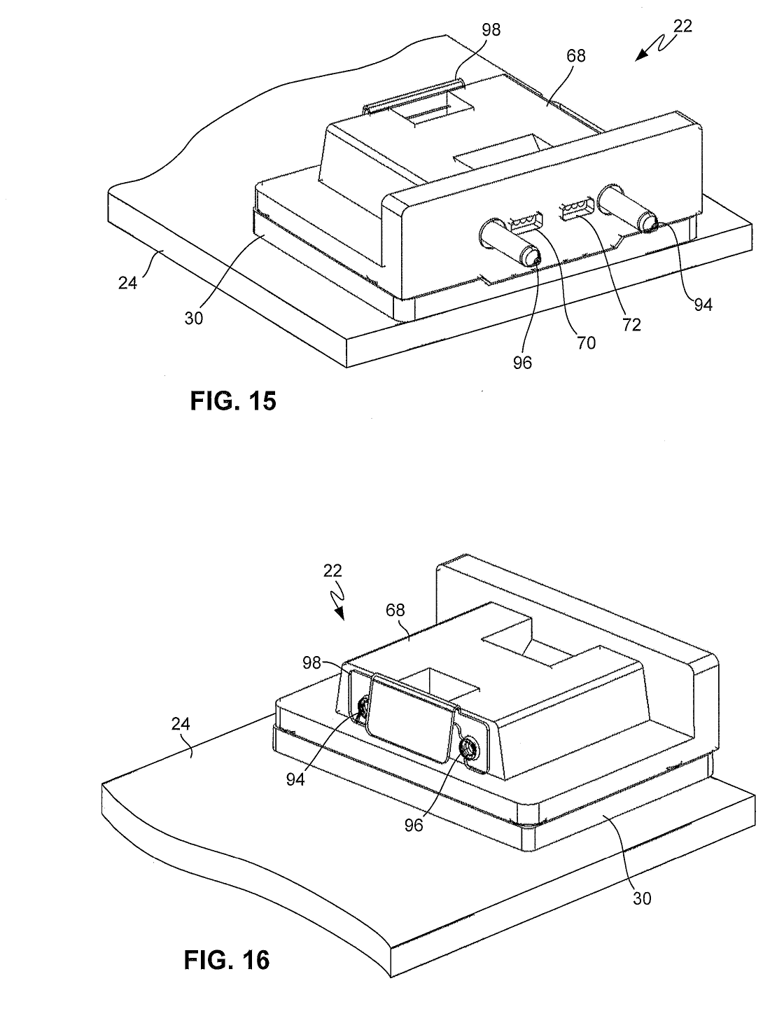

With reference again to FIGS. 9-10, top lens device 68 has two bores 90 and 92 extending between the forward and rearward ends of top lens device 68. As illustrated in FIGS. 15-16, in the assembled optical communications module 10 two guide pins 94 and 96 extend through bores 90 and 92, respectively. A retaining plate 98 abuts the rearward end of top lens device 68 and has slots that engage grooves in the rearward ends of guide pins 94 and 96.

Plugging MPO connector 20 into optical communications module 10 in preparation for the above-described operation can cause MPO connector 20 to exert mechanical forces upon top lens device 68. Although not shown for purposes of clarity, the end of MPO connector 20 has bores that receive guide pins 94 and 96. Such a mechanical connection can transmit mechanical forces from MPO connector 20 to top lens device 68. By spacing or separating top lens device 68 from bottom lens devices 62 and 64, mechanical forces acting upon top lens device 68 are not directly transferred to bottom lens devices 62 and 64 but rather are directly transferred to lens mounting frame 30 and then from lens mounting frame 30 to PCB 24.

It should be noted that good alignment among elements in the transmit optical path 86 depends to a greater extent upon good alignment between transmit bottom lens device 62 and opto-electronic light source 44 than it does upon good alignment between other elements in transmit optical path 86. Likewise, good alignment among elements in the receive optical path 88 depends to a greater extent upon good alignment between receive bottom lens device 64 and opto-electronic light detector 46 than it does upon good alignment between other elements in receive optical path 88. Thus, spacing or separating top lens device 68 from bottom lens devices 62 and 64 helps minimize adverse effects of mechanical forces upon top lens device 68 while not significantly sacrificing optical alignment.

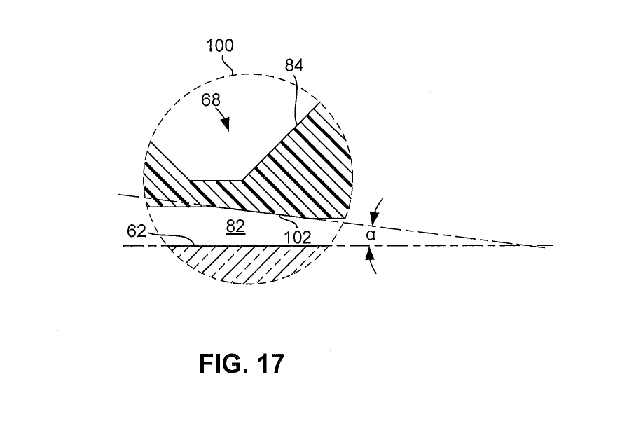

Spacing or separating top lens device 68 from bottom lens devices 62 and 64 also facilitates providing features that inhibit back reflection of the optical signals. The region 100 in FIG. 14 is shown enlarged in FIG. 17 to illustrate the slight angle (“α”) of, for example, about 5 degrees, between the upper surface of transmit bottom lens device 62 and the adjacent interior wall 102 of top lens device 68 (within cavity 82). If the upper surface of transmit bottom lens device 62 were parallel to interior wall 102 of top lens device 68, interior wall 102 could undesirably reflect some portion of the light emitted by opto-electronic light source 64 at an angle of 180 degrees back upon opto-electronic light source 64. The angled interior wall 102 inhibits such back reflection by reflecting that portion of light at an angle other than 180 degrees. The angle α can be any suitable non-zero angle between about 2-10 degrees, such as, for example, 5 degrees. In addition, or alternatively to orienting interior wall 102 at an angle, interior wall 102 or the upper surface of transmit bottom lens device 62 can be coated with an anti-reflection coating.

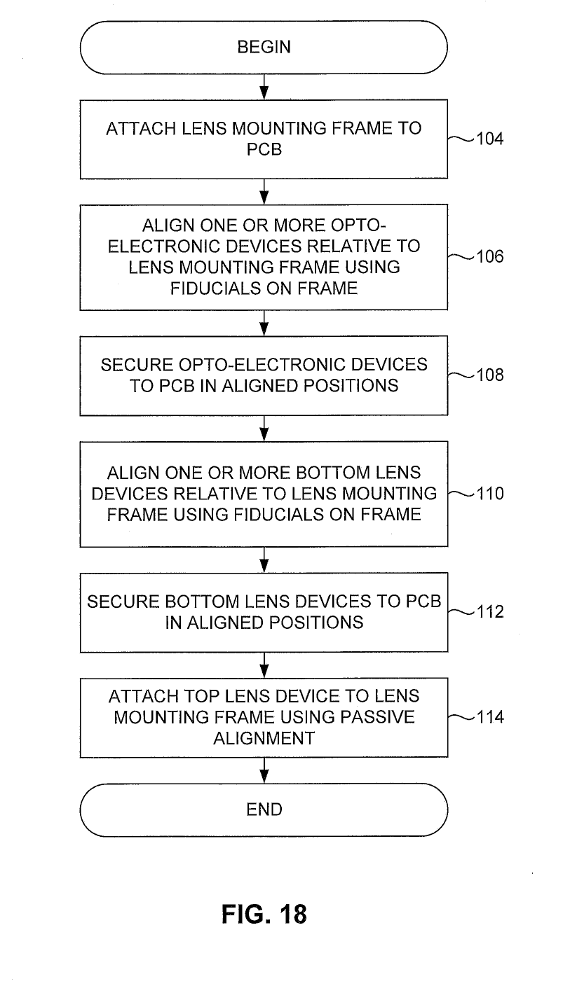

The exemplary method described above with regard to FIGS. 1-17 also can be described with reference to the flowchart of FIG. 18. As indicated by block 104, a lens mounting frame is attached to a PCB. As indicated by block 106, one or more opto-electronic devices are then aligned relative to fiducial markings on the lens mounting frame. As indicated by block 108, the opto-electronic devices are secured to the PCB in their aligned positions. As indicated by block 110, one or more bottom lens devices are aligned relative to the fiducial markings on the lens mounting frame. As indicated by block 112, the bottom lens devices are secured to the PCB in their aligned positions. As indicated by block 114, a top lens device is then attached to the lens mounting frame using a passive alignment method, such as the above-described mating of alignment posts and alignment holes.

One or more illustrative embodiments of the invention have been described above. However, it is to be understood that the invention is defined by the appended claims and is not limited to the specific embodiments described.

What is claimed is:

1. A method for making an electro-optical assembly of an optical communications module, comprising:
attaching a lens mounting frame to a surface of a printed circuit board (PCB), the lens mounting frame having a generally planar shape and a perimeter surrounding an interior opening, the perimeter having a frame lower surface defining a first plane and a frame upper surface defining a second plane, wherein attaching the lens mounting frame to the surface of the PCB comprises attaching the frame lower surface to the surface of the PCB, the frame upper surface bearing a plurality of fiducial markings;
aligning an opto-electronic device relative to the lens mounting frame by detecting the fiducial markings and moving the opto-electronic device into an aligned opto-electronic device position in response to detection of the fiducial markings;
securing the opto-electronic device to the surface of the PCB in the aligned opto-electronic device position within the interior opening of the lens mounting frame;
aligning a bottom lens device relative to the lens mounting frame by detecting the fiducial markings and moving the bottom lens device into an aligned lens device position over the opto-electronic device in response to detection of the fiducial markings;
securing the bottom lens device in the aligned lens device position; and
attaching a top lens device to the lens mounting frame over the bottom lens device by placing a base portion of the top lens device in contact with the frame upper surface.

2. The method of claim 1, wherein attaching a top lens device to the lens mounting frame includes mating alignment posts with alignment holes.

3. The method of claim 2, wherein the alignment posts extend from the base portion of the top lens device, and the frame upper surface has the alignment holes.

4. The method of claim 2, wherein attaching a top lens device to the lens mounting frame includes laser welding the top lens device to the lens mounting frame after mating the alignment posts with the alignment holes.

5. The method of claim 1, further comprising:
molding the lens mounting frame as a solid mass of molded material in which the alignment holes are co-formed with the fiducial markings; and
molding the top lens device as a solid mass of molded material in which the alignment posts are co-formed with a lens.

6. The method of claim 1, wherein detecting the fiducial markings comprises a robotic system optically detecting the fiducial markings and moving the opto-electronic device into the aligned opto-electronic device position.

7. The method of claim 1, wherein securing the bottom lens device in the aligned lens device position comprises applying a non-structural adhesive material.

8. The method of claim 1, wherein the bottom lens device consists of molded optically transparent material having a plurality of lenslets.

9. The method of claim 1, wherein:
aligning an opto-electronic device comprises aligning a first opto-electronic device and aligning a second opto-electronic device;
securing the opto-electronic device comprises securing a first opto-electronic device and securing a second opto-electronic device;
aligning a bottom lens device comprises moving the first bottom lens device into an aligned first lens device position over the first opto-electronic device in response to detection of the fiducial markings and, independently of the first bottom lens device, moving the second bottom lens device into an aligned second lens device position over the second opto-electronic device in response to detection of the fiducial markings; and
securing the bottom lens device in the aligned lens device position comprises securing the first bottom lens device and securing the second bottom lens device.

10. The method of claim 9, wherein:
the first opto-electronic device is a light source device having a plurality of laser elements; and
the second opto-electronic device is a light detector device having a plurality of photodiode elements.

11. The method of claim 1, wherein the top lens device is spaced apart from the bottom lens device by a gap.

12. The method of claim 11, wherein the gap spaces apart an interior wall of the top lens device and an adjacent surface of the bottom lens device, and the interior wall of the top lens device and the adjacent surface of the bottom lens device are oriented at a non-zero angle with respect to each other.

13. The method of claim 11, wherein the gap spaces apart an interior wall of the top lens device and an adjacent surface of the bottom lens device, and one of the interior wall of the top lens device and the adjacent surface of the bottom lens device has an anti-reflection coating.

14. A method for making an electro-optical assembly of an optical communications module, comprising:
attaching a lens mounting frame to a surface of a printed circuit board (PCB), the lens mounting frame having a generally planar shape and a perimeter surrounding an interior opening, the perimeter having a frame lower surface defining a first plane and a frame upper surface defining a second plane, wherein attaching the lens mounting frame to the surface of the PCB comprises attaching the frame lower surface to the surface of the PCB, the frame upper surface bearing a plurality of fiducial markings;
aligning an opto-electronic device relative to the lens mounting frame by detecting the fiducial markings and moving the opto-electronic device into an aligned opto-electronic device position in response to detection of the fiducial markings;
securing the opto-electronic device to the surface of the PCB in the aligned opto-electronic device position within the interior opening of the lens mounting frame;
aligning a bottom lens device relative to the lens mounting frame by detecting the fiducial markings and moving the bottom lens device into an aligned lens device position over the opto-electronic device in response to detection of the fiducial markings;
securing the bottom lens device in the aligned lens device position; and
attaching a top lens device to the lens mounting frame over the bottom lens device by passively aligning the top lens device and the lens mounting frame, and mounting a base portion of the top lens device to the frame upper surface.

15. The method of claim 14, wherein passively aligning the top lens device and the lens mounting frame includes mating alignment posts with alignment holes.

16. The method of claim 14, further comprising:
molding the lens mounting frame as a solid mass of moldable material in which the alignment holes are co-formed with the fiducial markings; and
molding the top lens device as a solid mass of the moldable material in which the alignment posts are co-formed with a lens.

17. The method of claim 14, wherein detecting the fiducial markings comprises a robotic system optically detecting the fiducial markings and moving the opto-electronic device into the aligned opto-electronic device position.

18. The method of claim 14, wherein securing the bottom lens device in the aligned lens device position comprises applying a non-structural adhesive material.

19. The method of claim 14, wherein:
aligning an opto-electronic device comprises aligning a first opto-electronic device and aligning a second opto-electronic device;
securing the opto-electronic device comprises securing a first opto-electronic device and securing a second opto-electronic device;
aligning a bottom lens device comprises moving the first bottom lens device into an aligned first lens device position over the first opto-electronic device in response to detection of the fiducial markings and, independently of the first bottom lens device, moving the second bottom lens device into an aligned second lens device position over the second opto-electronic device in response to detection of the fiducial markings; and
securing the bottom lens device in the aligned lens device position comprises securing the first bottom lens device and securing the second bottom lens device.

20. The method of claim 19, wherein:
the first opto-electronic device is a light source device having a plurality of laser elements; and
the second opto-electronic device is a light detector device having a plurality of photodiode elements.

21. The method of claim 20, wherein:
the first bottom lens device consists of molded optically transparent material having a plurality of lenslets aligned with corresponding laser elements; and
the second bottom lens device consists of molded optically transparent material having a plurality of lenslets aligned with corresponding photodiode elements.
